(19) United States
(12) Patent Application Publication
(10) Pub. No.: US 2015/0293953 A1
(43) Pub. Date: Oct. 15, 2015

(54) ROBUST, LOW-OVERHEAD, APPLICATION TASK MANAGEMENT METHOD

(71) Applicants: David William Wicks, Houston, TX (US); Yonghe J. Sun, Cypress, TX (US)

(72) Inventors: David William Wicks, Houston, TX (US); Yonghe J. Sun, Cypress, TX (US)

(73) Assignee: CHEVRON U.S.A. INC., San Ramon, CA (US)

(21) Appl. No.: 14/250,521

(22) Filed: Apr. 11, 2014

(51) Int. Cl. G06F 17/30

(52) U.S. Cl. CPC G06F 17/30312; G06F 17/30362

(57) ABSTRACT

Application task management (“ATM”) methods may employ a task list stored in a file on a nonvolatile information storage medium. Parallel processing instances employ an application programming interface (“API”) that enables each processing instance to individually access the task list. The access protocol enforced by the API is sufficient to provide robust, fault-tolerant behavior without requiring a specific process or daemon to be responsible for ATM. The API may employ a locking mechanism based on universal or widely-available operating system calls (such as directory creation) that implicitly or explicitly guarantee atomic operations. Each processing instance performs a check-out of unfinished tasks with a request that includes a timeout value, transforms the unfinished tasks into finished tasks, and provides a check-in of the finished tasks, and repeats. This approach supports the use of a variety of models through the use of chained or nested task lists, and it can be readily scaled.

### BACKGROUND

High-performance computing (“HPC”) is the commonly-employed term for describing systems and methods providing aggregated computational resources that cooperate to solve those problems that cannot be adequately addressed by a typical workstation or desktop computer system. As such, the scope of this term changes based on the current technology available in commodity computer systems, but in any event it is understood here to require the use of many processing units (computers, processors, cores, threads, or virtual equivalents thereof) operating on the problem in parallel.

As the number of processing units grows, so too does the challenge of efficiently coordinating their operation. In fact, the chosen coordination strategy often becomes a limiting factor on the maximum number of processing units. Moreover, once the number of processing units exceeds a reliability-based threshold, the coordination method must be designed to tolerate communication errors and even the failure of processing units and/or other system components. Otherwise a single failure can result in the loss of many processing unit-months of effort.

In addition to the foregoing, many existing coordination methods are unnecessarily difficult for programmers to employ, in that their implementations impose certain assumptions regarding the usage model and the underlying operating system and/or hardware platform. For example, the usage model may require a daemon or other unique process to serve as a central coordinator. As another example, the usage model may require a “master” process or monitor system to supervise other processes, imposing a potentially unnecessary hierarchy into the software. While such model assumptions may be useful in some applications, they should not be requirements for all applications. Similarly, the chosen coordination method should not prevent the application software from being portable to other operating systems and hardware platforms.

### SUMMARY

Accordingly, there are disclosed herein robust, low-overhead, application task management methods and certain embodying systems. In one embodiment, an application task management method includes: populating a data structure with a list of one or more tasks, at least one of which is unfinished; and operating a pool of multiple processing instances until the unfinished tasks are completed. Each processing instance: performs a check-out of one or more unfinished tasks with a check-out request that includes an ID of the processing instance and a task timeout value; transforms the one or more unfinished tasks into one or more finished tasks; provides a check-in of the one or more finished tasks; and optionally repeats the performing, transforming, and providing, while using a file lock to ensure exclusive access to the data structure.

A system embodiment includes: a non-transient information storage medium having a data structure with a list of one or more tasks for a high-performance computing application; and one or more processing units that together execute a pool of multiple processing instances. Each processing instance: performs a check-out of one or more unfinished tasks with a check-out request that includes an ID of the processing instance and a task timeout value; transforms the one or more unfinished tasks into one or more finished tasks; provides a check-in of the one or more finished tasks; and optionally repeats the performing, transforming, and providing, while using a file lock to ensure atomic access to the data structure.

### BRIEF DESCRIPTION OF THE DRAWING

FIG. 1 is a block diagram of an illustrative high-performance computing (“HPC”) system.

FIG. 2 is a block diagram of illustrative HPC application software.

FIG. 3 illustrates certain application task management communications.

FIG. 4 is a flowchart of an illustrative application task management method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

Certain illustrative application task management (“ATM”) methods disclosed herein employ a task list stored in a file on a shared disk or other nonvolatile information storage medium. The various parallel processing instances employ an application programming interface (“API”) that enables each processing instance to individually access the task list. The access protocol enforced by the API is sufficient to provide robust, fault-tolerant behavior without making a specific process or daemon responsible for ATM. The API may be implemented as a linked library and/or as a set of remote procedure calls. Either approach may employ a locking mechanism based on universal or widely-available operating system calls (such as directory or file access operations) that implicitly or explicitly guarantee atomic operations.

One illustrative ATM method embodiment includes: populating a data structure with a list of one or more tasks, at least one of which is unfinished; and operating a pool of multiple processing instances until no unfinished tasks remain in the list. Each processing instance performs a check-out of one or more unfinished tasks with a check-out request that includes an ID of the processing instance and a task timeout value, transforms the unfinished tasks into finished tasks, provides a check-in of the finished tasks, and repeats. A locking mechanism is used to ensure that each check-out and check-in operation is performed with exclusive access to the data structure. This approach enables concurrent processing of tasks while imposing no particular framework assumptions for the parallel processing model being employed. Yet it supports the use of a variety of models through the use of chained or nested task lists, and it can be readily scaled to support large numbers of tasks and processing instances.

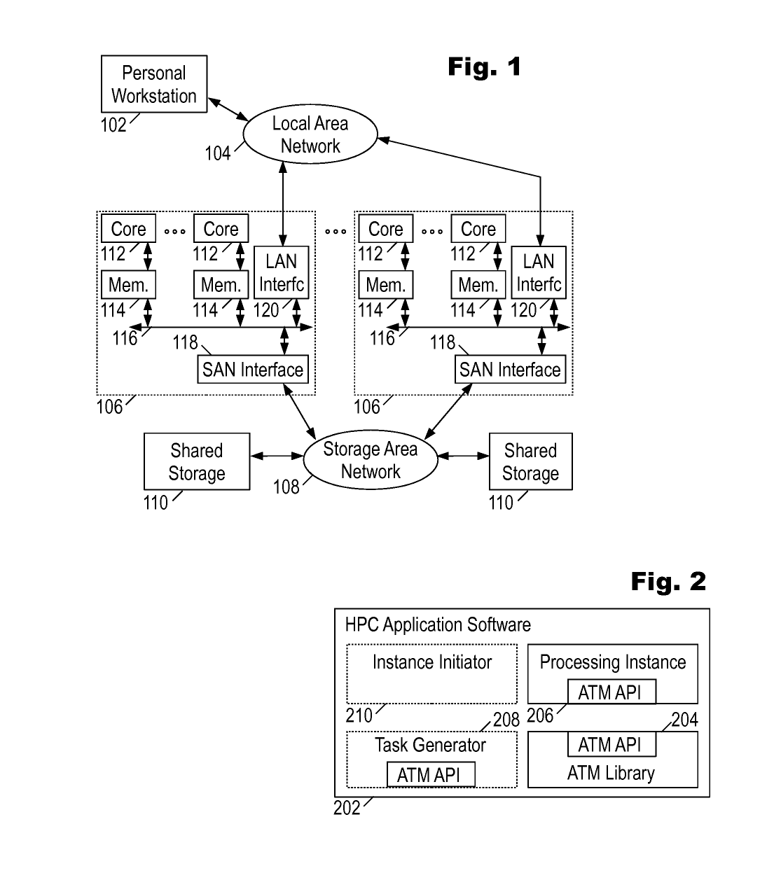

To provide context for further discussion, FIG. 1 shows an illustrative high-performance computing (“HPC”) system having a personal workstation 102 coupled via a local area network (LAN) 104 to one or more multi-processor computers 106, which are in turn coupled via a storage area network (SAN) 108 to one or more shared storage units 110. Personal workstation 102 serves as a user interface to the HPC system, enabling a user to load data into the system, to configure and monitor the operation of the system, and to retrieve the results (often in the form of image data) from the system. Personal workstation 102 may take the form of a desktop computer with a graphical display that graphically shows representations of the input and result data, and with a keyboard that enables the user to move files and execute processing software. LAN 104 provides high-speed communication between multi-processor computers 106 and with personal workstation 102. The LAN 104 may take the form of an Ethernet network.

Multi-processor computer(s) 106 provide parallel processing capability to enable suitably prompt processing of the input data to derive the results data. Each computer 106 includes multiple processors 112, distributed memory 114, an internal bus 116, a SAN interface 118, and a LAN interface 120. Each processor 112 operates on allocated tasks to solve a portion of the overall problem and contribute to at least a portion of the overall results. Associated with each processor 112 is a distributed memory module 114 that stores application software and a working data set for the processor's use. Internal bus 116 provides inter-processor communication and communication to the SAN or LAN networks via the corresponding interfaces 118, 120. Communication between processors in different computers 106 can be provided by LAN 104.

SAN 108 provides high-speed access to shared storage devices 110. The SAN 108 may take the form of, e.g., a Fibrechannel or Infiniband network. Shared storage units 110 may be large, stand-alone information storage units that employ magnetic disk media for nonvolatile data storage. To improve data access speed and reliability, the shared storage units 110 may be configured as a redundant disk array (“RAID”).

Illustrative applications of the illustrated HPC system include wavefield migration, seismic imaging, interactive modeling, tomographic analysis, velocity inversion, database management, data mining, corpus processing, cryptoanalysis, and simulation of reservoirs, fluid flows, chemical interactions, and other complex systems. Many such applications are known along with various strategies for dividing the overall problem into tasks that can be performed concurrently by different processing instances. As shown in FIG. 2, the application software 202 may include various software modules 204-210.

One illustrated software module is a linked ATM library 204 that supports an ATM API for use by other software modules. As such, it supports function calls for checking out one or more unfinished tasks (“taskOut”) and for checking in finished tasks (“taskIn”). The API may further support function calls for returning checked-out but unfinished tasks (“taskCancel”), for extending the completion deadline of checked-out but unfinished tasks (“taskRenew”), for obtaining a processing instance ID (“signIn”), for adding new tasks (“taskAdd”), and for performing a progress check (“percentComplete”). These function calls can be made by other software modules, such as the processing instance module 206 and the optional task generator module 208. In one illustrative implementation, the library module 204 is implemented by Python scripts with C++ bindings to the various methods, but similar bindings could be made for any high-level programming language.

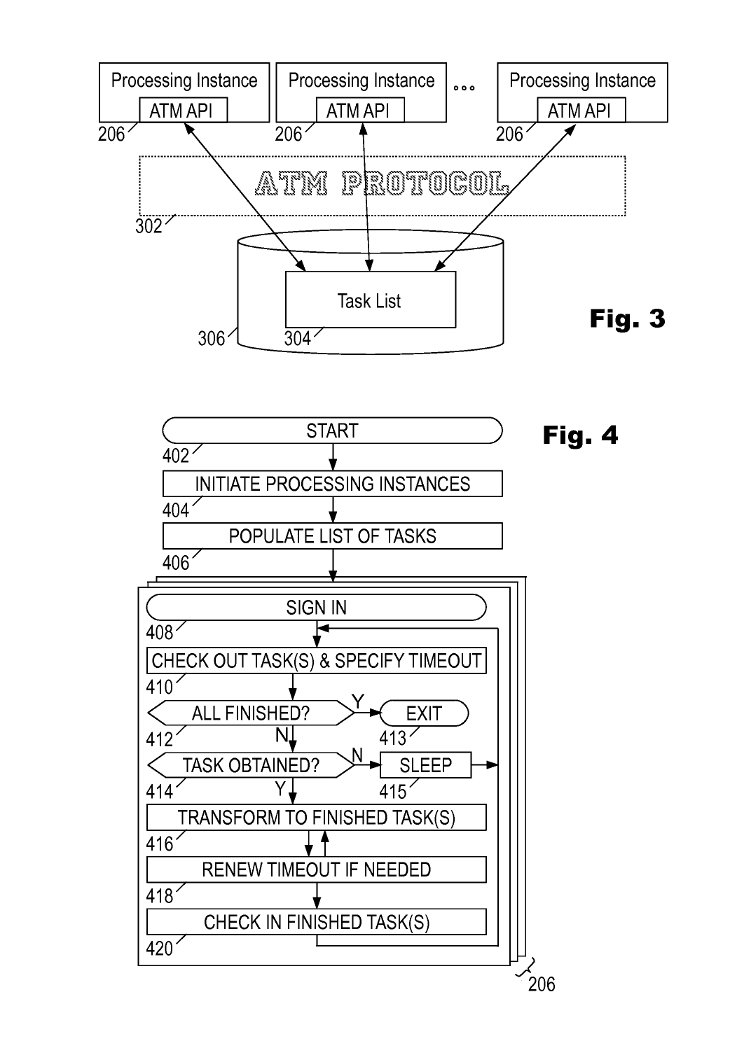

The processing instance module 206 is the code for a processing instance. As indicated in FIG. 3, multiple such processing instances may be running concurrently as independent threads on a given processor core and/or as independent processes on multiple processor cores. Depending on the model employed, the multiple processing instances may be initiated via repeated “fork” operations or the equivalent, and/or by remote procedure calls to software resident on other computers. The protocol 302 implemented by the ATM library 204 enables the various processing instances 206 to access a task list 304 that resides on a shared disk or other shared, nonvolatile information storage medium 306, optionally in the form of an ASCII file or data structure. Each processing instance 206 obtains one or more tasks using the ATM API check-out operation, transforms unfinished tasks into finished tasks, and indicates the completion of these tasks via the ATM API check-in operation.

The task list 304 can be populated with tasks in any one of multiple ways. Each task is represented by a character string or byte array that can be parsed by the processing instances, and there is no restriction on what a task can be (e.g. an identifier of a data chunk to process, a ticket for access to a limited resource, an action to be performed). Tasks may be separated by line breaks, commas, or other delineators. In the discretion of the programmer, the task list may be generated as a static list, as a dynamic list, or as some combination thereof That is, at least some of the tasks needed to solve the problem may be known and included in the list when the application software is initiated. Conversely, at least some of the tasks may be determined on the fly, as their necessity is discovered in response to the outcome of previous tasks or in response to environmental inputs (e.g., the submission of tasks by system users). Though it is expected that most of the tasks will represent parts of the problem that can be processed independently of other parts, some of the tasks may relate to coordination or other administrative tasks such as collecting and combining the results of the previously finished tasks. Any dependencies between tasks can, at the discretion of the programmer, be accounted for with the use of nesting and/or chaining

In some embodiments, task nesting may be implemented by having a processing instance generate a list of subtasks for a given task, and initiate a sub-hierarchy of processing instances to transform the unfinished subtasks into finished subtasks. In some embodiments, task chaining may be implemented by having a processing instance monitor the task list for completion of certain (or even all) pending tasks and, upon detecting such completion, adding new tasks to the list. In both cases, the use of the task list for nesting or chaining behaviors means that any one of the processing instances could temporarily assume the role of a “master” instance. This democratic structure, coupled together with the fault tolerance features discussed below, greatly enhances the robustness of the ATM protocol relative to systems having a federated architecture.

Returning to FIG. 2, the application software 202 may include optional task generator module 208 to populate the task list using the ATM API task addition operation. The task generator functionality may be implemented as a part of the processing instance module 206 or, for example, kept separate as part of an initiating process that provides a predetermined set of tasks. Alternatively, an interface process may intercept requests from users, sensors, or other systems, and responsively add corresponding tasks to the list. The application software may further include an instance initiator 210 to launch the multiple processing instances 206 or otherwise initiate their activities on the tasks in the list. In some embodiments, the instance initiator may take the form of an activity monitor that detects when tasks are not being completed with adequate alacrity and responsively launches additional instances, with commensurate allocation of available system resources. The initiator may additionally or alternatively detect failed or frozen (or unneeded) processing instances and reclaim their allocated resources, possibly for use by replacement processing instances.

FIG. 4 is a flowchart of an illustrative ATM method 402. Though shown as a sequential set of actions for ease of explanation, the illustrated actions may in fact be performed concurrently or in a different order. As the application software 202 is executed, it causes a HPC system to initiate multiple processing instances 206 to employ parallel computing resources for concurrent processing of tasks. This initiation action is represented by block 404. It should be noted that this initiation action may be optionally performed as a ongoing background process that initiates new processing instances as new resources become available (e.g., when a new computer joins the network or an unrelated application terminates) or as determined necessary (e.g., upon determining that one or more processing instances have failed or need to be migrated from a computer departing the network).

Block 406 represents the software's action of populating a task list with tasks to be performed as part of performing the application's purpose, e.g., processing a portion of a data set, simulating behavior of selected elements, evaluating one portion of a solution space, or the like. The list preferably includes task identifiers such as alphanumeric strings or binary records that, when parsed by the processing instances, represent the particular task to be carried out by the processing instance. As explained further below, each task identifier may also have a corresponding client identifier to indicate which processing instance (if any) has assumed responsibility for finishing the task by checking it out, and a timeout value to indicate when that responsibility may be assumed by another processing instance.

Blocks 408-420 represent actions taken by each of the processing instances 206. In block 408, the processing instance optionally initializes the ATM API, e.g., by calling a sign-in method (“sign_on”) that establishes a unique identifier for the processing instance, and establishes which ATM data file will be used for subsequent operations. The ATM data file includes a list of task identifiers (“taskId”), and for each task identifier, may further include (where applicable) a client identifier (“clientId”) indicating which processing instance has checked out the task, a start time indicating when the task was checked out, a timeout attribute indicating when the processing instance's time for finishing a task expires, and a stop time indicating when the task was finished.

In block 410, the processing instance uses the ATM API by calling a check-out method (“taskOut”). The check-out method accepts a parameter indicating a timeout value and a maximum number of tasks to be returned in response to the check-out. The check-out method first returns unassigned tasks, then searches for tasks that have timed out, then if no such tasks can be found, it determines if all tasks have been finished. In block 412, the processing instance determines if all tasks have finished, and if so, it exits the current phase of processing via block 413. If at least one task is unfinished but no tasks were returned by the check-out method as determined in block 414, then in block 415 the processing instance sleeps for an interval and returns to block 410. Otherwise, in block 416 the processing instance parses each obtained task identifier to determine the task(s), obtains the necessary data, and operates to transform the unfinished tasks into finished tasks. The output of the finished task is delivered and/or stored for later access as provided by the application software. If needed, the processing instance may periodically renew the timeout (“taskRenew”) in block 418 to prevent time from elapsing before the task is finished. (Some software applications may employ this feature to implement a so-called “heartbeat” indicator of continued activity on the task.) Once the task(s) are finished, in block 420 the processing instance calls a check-in method (“taskIn”) with the task identifier to mark the appropriate task as finished. The processing instance then returns to block 410.

It should be recognized that the foregoing is simply one way to employ the disclosed ATM protocol. As indicated further below, the ATM API supports a wide variety of usage methods and application contexts. We turn now to details of one particular implementation of the ATM API, but it should be recognized that many such implementations are possible and readily perceived by those of ordinary skill in the art.

In some embodiments, the ATM may be considered in terms of three major components: a C++ front end library for use by C++ applications; a Python library, which takes the form of a collection of utility scripts that actually perform the ATM actions; and a Python back end server that acts a bridge between the C++ front end library and the Python library. As mentioned previously, the components may be in any suitable computer language or code known to those of skill in the art.

The C++ front end library contains a number of task management commands in the form of callable functions (described in greater detail below). All functions in this library operate by launching a single-use Python server process that services the request being made. That server process may be launched using an embedded command-line pipe that launches the Python interpreter, passes request data to that interpreter, and collects results from that interpreter. The front end may be distributed in the form of a shared object library and a header file for use by application developers.

Among the classes (and corresponding objects) that may be defined in an illustrative library is a “taskInfo” class that serves as a data structure for the details of an individual task. The structure may include a unique task identifier (“taskId”) that gets dynamically associated with a respective task when it is returned by the “taskOut” call, a client identifier (“appId”) associated with the processing instance (or other process) that currently has ownership of the task, and a boolean flag (“complete”) that indicates whether all tasks in the associated task list are finished. An “ATMException” class may be defined as a base class for managing a message string associated with exceptions. An “ATMInvalidTaskException” object is defined as a subclass of the “ATMException” class to serve as a mechanism for delivering an exception from functions that attempt to operate on a task that is not owned by the current processing instance. An “ATMIOException” class may also be defined as a subclass of the “ATMException” class to serve as a mechanism for flagging I/O errors.

An “AppTaskMgr” class may be defined to provide the processing instances or other C++ clients with access to the ATM API function calls. It may include the following methods. The “AppTaskMgr(string wpName)” method is a constructor that creates an ATM object and associates it with a task list. That object will have a unique client identifier that will be associated with tasks that this client receives to work on. The “taskInfo taskOut(int timeout)” method is a check-out call that checks out a single task from the task list and associates a timeout (in seconds) with that task. As indicated by the “taskInfo” class that precedes the name of the method, the taskOut( ) method returns a taskInfo data structure. The “std::list<taskInfo> taskOut(int timeout, int nTasks)” method is a check-out call that checks out one or more tasks (up to nTasks) and returns a list of taskInfo data structures.

Also in the AppTaskMgr class is the “boolean taskRenew(int timeout)” method, which applies a new timeout value to all tasks currently checked out by this processing instance such that tasks will expire “timeout” seconds after the current system time when the method is called. The “boolean taskRenew(int timeout, std::string taskId)” method applies a new timeout value to the single identified task such that the task will timeout after “timeout” seconds from the current time, whereas the boolean taskRenew(int timeout, std::list<std::string>taskIds) applies a new timeout value to a list of identified tasks such that each of these tasks will timeout after “timeout” seconds from the current time. The boolean taskIn( ) method checks in as completed all tasks currently checked out by this client instance. The boolean taskIn(std::string taskId) method checks in a single identified task as complete, whereas the boolean taskIn(std::list<std::string>taskIds) method checks in a list of identified tasks as complete. The boolean taskCancel( ) method cancels all tasks currently checked out by this client instance. The boolean taskCancel(std::string taskId) method cancels a single identified task, whereas the boolean taskCancel(std::list<std::string> taskIds) method cancels a list of identified tasks. The boolean return value of each of these methods indicates whether the attempted transaction was performed successfully. A float percentComplete( ) method returns the percent of tasks in the list that have been checked in as complete.

The supporting code for the above library methods operates by launching an ATMServer Python script with suitable input and output pipes connected to it. They push functional requests into the ATMServer standard input via a pipe and pull output from the ATMServer standard output by another pipe. The ATMServer Python script pulls request data from command line arguments and from the input pipe it receives from the C++ client and it pushes results onto its output pipe which gets returned to the C++ client. Among the recognized requests is a sign_on request, which returns a unique, dynamically generated application ID string that the C++ client will use to identify itself for subsequent transactions. The sign_on request further initializes an ATM task XML data structure from a task list file if this is the first time that this task list file has been used.

Also among the recognized requests is a task_out request is used to check out one or more tasks and to determine the completion status of a task list. The inputs associated with a task_out request are: a task timeout value in seconds, and a number of tasks to request. The outputs are: a boolean completion status, with true indicating that all tasks are complete, and false indicating that all tasks are not complete; and a list of taskIds that were obtained. A single taskId that is an empty string indicates that there are no tasks available at this time. Even if there are no tasks available at this time, it is possible that a subsequent taskOut call will return a task if one or more tasks times out. The completion status may be the only indication that a task list is complete. An error output is also provided to indicate if any errors occurred during processing.

A “task_renew” request updates the timeout value associated with one or more tasks. The inputs are: a new timeout value (in seconds), and a list of tasks to which the new timeout value is to be applied. The current timeout attribute will be replaced with a new timeout value that is “timeout” seconds after the current system time, and it represent the time at which a task timeout will occur if the task is not finished or renewed before then. The return value of the task_renew request is a completion status to indicate if the request completed successfully or not. A failure may occur, for example, if a processing instance attempts to renew a task that it does not currently own. If a failure occurs, an error message is provided.

A “task in” request checks in one or more tasks as finished. The inputs include a list of tasks to be checked in. The return value of the request is a completion status to indicate if the request completed successfully or not. As before, the request may fail if the processing instance attempting the check in does not currently own the task, and an error message is provided. A “task cancel” request cancels one or more checked-out tasks, making them available for checkout by another client. The inputs include a list of one or more tasks to be canceled. The return value indicates whether the request was successful, and if not, an error message is provided. A “percent_complete” request receives a return value indicating the percentage of tasks which have been completed. By default, the return value is 100% when the task list is empty.

To service the foregoing requests, the ATMServer script relies on a library of utility scripts including “ATMActions.py”, “ATMData.py”, and “lockManager.py”. The last of these is available as a public distribution. The “ATMActions.py” script contains a series of functions that perform the various actions that can be requested by ATMServer. The “taskOut(timeout, nTasks)” function attempts to check out “nTasks” tasks, each with a timeout of “timeout” seconds. It creates a (initially empty) task list to provide the return values, and sets the completion flag to False. The function then calls “lockManager” to obtain a lock to the data file containing the task list. If the lock is obtained, the function calls “ATMData” to read the data file into memory, and searches the list for unassigned tasks (unfinished tasks that are not currently checked out) and stores the first nTasks into the list. If nTasks are not found the function attempts to supplement the list with timed-out tasks (unfinished tasks that are checked out and the timeout has elapsed). Any tasks in the list are assigned (or re-assigned) to the requesting processing instance, with the appropriate timeout value. If the list is empty, the function determines whether all of the tasks are finished, and if so, it sets the completion flag to True, indicating that all tasks in the list have completed. ATMData is called to write the updated task list back to the data file on disk, and the lockManager is called to release the lock. The function then returns the task list and completion flag.

The “taskRenew(timeout, taskIds)” function attempts to reset task timeouts for a list of taskIds such that their new timeout will reflect an expiration time that is “timeout” seconds from the current time. The function calls “lockManager.py” to obtain a lock on the data file containing the task list (“the ATM data file”), and if successful calls “ATMData.py” to read the data file into memory. The function verifies that all taskIds are currently checked out to the calling processing instance. The function exits with an error message if any task is not owned by the calling instance or if the task does not exist. Otherwise, the function determines the current time and adds the timeout period to determine a timeout time, and adjusts the timeout attribute for all matching tasks accordingly. The function calls “ATMData.py” to write the updated Python data model back to ATM data file, and calls “lockManager.py” to release lock for the ATM data file. The function then returns “True” to indicate successful completion.

The “taskIn(taskIds)” function performs a check-in for each task in a list of taskIds. The function calls “lockManager.py” to obtain a lock for the ATM data file, then uses “ATMData.py” to read the contents of the ATM data file into a Python data model in memory. The function verifies that all taskIds are currently checked out to the current client (the processing instance that called the taskIn function). The function exits with an error if the task is not owned by the current client or if the task does not exist. Otherwise the function sets a “stop” attribute for each identified task to the current time to indicate that the task is finished, and clears the associated timeouts for those tasks. The function uses “ATMData.py” to write the contents of the updated Python data model back to ATM data file, uses “lockManager.py” to release the lock for this ATM data file, and returns True to indicate successful completion.

The “taskCancel(taskIds)” function resets a list of checked-out tasks associated with taskIds to an unstarted state. The function calls “lockManager.py” to obtain a lock for this ATM data file, and if successful, calls “ATMData.py” to read the ATM data file into a Python data model in memory. The function verifies that all taskIds are currently checked out to the current client, and exits with an error if any of the specified tasks are not owned by the current client or does not exist. Otherwise, the function re-initializes all attributes of the specified tasks back to an unstarted state. The function then uses “ATMData.py” to write the updated Python data model back to the ATM data file, and uses “lockManager.py” to release the lock. The function then returns True to indicate successful completion.

The “percentComplete( )” function returns the percent of tasks that are complete. The function uses “lockManager.py” to obtain a lock for the ATM data file, uses “ATMData.py” to read the contents of the ATM data file into memory, and calls “lockManager.py” to release the lock. The function counts the number of finished tasks and the total number of tasks to compute and return the percent of tasks that are complete.

The “getUnassignedTask( )” function is called by the “taskOut( )” function to locate unassigned tasks. This function iterates through the list of tasks in the Python data model, searching for a task that lacks a “start” attribute. When a suitable task is found, the function sets the task's clientID, start, and timeout attributes, and return that taskId to the taskOut function, or “None” if no unassigned task is found.

The “getTimedOutTask( )” function is called by the taskOut( ) function to locate timed-out tasks. The function iterates through the list of tasks in the Python data model, searching for a task that has timed out. Depending on implementation, this test may be performed by searching for a task having clientID other than that of the calling instance and further having a “start” attribute and a “timeout” attribute that add together to yield a time later than the current time. The function returns “None” if no timed-out tasks are found. Otherwise, the function, having identified a timed-out task owned by a given processing instance, the function calls “taskCancel” function with this task and any other tasks assigned to the given processing instance. The taskCancel function converts the timed-out task(s) into unassigned tasks as described above. The “getTimedOutTask( )” function then calls and returns using the “getUnassignedTask( )” function.

The “ATMData.py” script is used to read task list from an ATM data file into a Python data structure in memory. In one embodiment it utilizes the Python XML.dom.minidom library to import and export XML data structures. It includes the “_init_(taskFileName, lockMgr, retryTime=30)” constructor function, which requires the path and file name of the ATM task list to be used and a reference to the lock that is currently being used to manage this task list. If this is the first time this task list file has been used, a new XML task document will be created using tasks in the task file, using the “createDoc( )” function. This function creates a new XML task document for the given ATM task list file. For each task it creates attributes:
taskId—the task string as found in the original task list file
appId—holds the client (processing instance) identifier when a client has checked out a task
host—holds a client host name when a client has checked out a task
start—holds a start time in seconds since 1970 when a client has checked out a task
stop—holds the stop time in seconds since 1970 when a client has checked in a task
timeout—holds the number of seconds after the start time before the task is considered to be timed out
   When setting up the initial XML document, only taskId need be defined. All other attributes may be empty strings. A check is made to ensure that no illegal characters are present in the task identifier, meaning no ASCII values less than 32 or greater than 126. A check is made to ensure that there are no duplicated tasks. (All task names should be unique.) An in-memory DOM (“document object model”) data structure is used to construct the XML, and a write( ) function (described below) is called to put the file to disk.

A “read( )” function reads the task XML file into a Python DOM data structure in memory. On a successful read the function exits with the task list loaded into memory. On a read failure the function sleeps for a default of 30 seconds, then calls lockMgr.touchLock( ) to reset the lock timeout associated with this task list, and loops to try again. A “write( )” function writes the DOM data structure into a temporary XML file. After a successful write, the function renames the temporary file to replace the ATM data file. If the write fails, the function sleeps for a default of 30 seconds, then calls a locking module, specifically in an embodiment, lockMgr.touchLock( ) to reset the timeout associated with this task list, and loops to try again.

The “lockManager.py” script provides functions for lock-coordinated access to ATM data files. It is used by “ATMActions” and “ATMData” scripts. In at least some implementations, lockManager uses a directory-based locking scheme, relying on the premise that the Linux “mkdir” operation (or its equivalent in other operating systems) is an atomic operation. This atomic status means that when mkdir is called, it will create the requested directory in a single step and it will either succeed or fail with no indeterminate halfway states where it is partially created and partially not created. If two or more attempts are made from multiple clients, at most one will succeed and all others will fail. As such, when lockManager creates a lock directory with no errors raised, it uses the success of that call to report back to the calling client that the client now has exclusive permission to perform actions associated with that lock. It includes an “_init_(lockDir, lockId, defaultTimeout, retryTime=120)” constructor function that initializes a LockManager object instance having the following attributes:
lockDir—the directory to be created and used as a lock indicator
lockId—an identifier used to identify the client that is trying to get a lock.
defaultTimeout—a default lock timeout to use if the client does not specify a timeout in the lock(timeout=None) method.
retryTime—The time to wait between attempts to get a lock. Default=120 seconds
lockInfoFile—path to a file containing information about the lock—used for debugging
lockMsgs—a list of informational messages about the lock

The lockManager script also includes a “_del_( )” destructor function for LockManager objects. The destructor function gets lock information by calling getLockInfo( ), returns if lockInfo contains no lockId (no lock to remove) or the wrong lockId (not my lock), and calls unlock(all=True) to clean up lock. A “lock(timeout=None, msg=‘No message’)” function obtains an exclusive resource lock by using mkdir as a test. If the lockMsgs attribute has a list length greater than zero, the current call to this function is a recursive or repeated lock attempt by a process that already owns the lock. The function adds a new message to the list, writes it to the lockInfo message file, restarts the lock timeout and returns. Otherwise the function verifies that the current user has permission to read and write the lock directory. It then loops until a lock is obtained (i.e., a lock directory is successfully created). The loop calls “mkdir(lockDir)”, and a successful call breaks out of the loop. Otherwise the loop calls “getLockInfo( )” to get and monitor the lock for any indications of activity. If too much time passes without any sign of activity, the loop calls “breakLock” in an attempt to force the lock to be released. Once a lock directory is successfully created, the function adds a message to the lockMsgs attribute and writes it to the lockInfo message file. If the lockInfo file write succeeds, the function returns. Otherwise the function deletes the lock directory and re-enters the loop.

ATM's usage of this locking mechanism ensures the integrity of the task completion state for all tasks, guaranteeing that all tasks really get finished and that no tasks are unnecessarily performed multiple times. This mechanism avoids the usual practice of implementing a daemon server process, and thereby eliminates a variety of failure scenarios. Whichever launching/management model that is employed by the application software need not be modified to accommodate the ATM protocol. The ATM protocol is implicitly initiated and applied when a running instance invokes the ATM API. Consequently, processing instances can be added or removed (intentionally or unintentionally) at any time. Even if all instances are terminated, starting new instances will result in the resumption of task processing which will continue until all tasks are completed.

Accordingly, the ATM protocol facilitates the development of distributed high-performance computing applications such as seismic imaging, subsurface modeling, tomography, reservoir simulation, and database management. One specifically contemplated application is seismic wave-equation tomographic velocity analysis, but other contemplated application include interactive and interpretive imaging. It coordinates the distribution of tasks and access to resources across multiple hosts in a fault tolerant manner. Stated in another fashion, the disclosed methods facilitate programmers' access to fault tolerant, parallelizable assignment of tasks across multiple concurrently running task processing instances. The disclosed methods may also facilitate allocation of a pool of a limited resources (I/O device access, software license pools, cluster host access, etc.) when resource demand exceeds resource availability. Such capabilities are helpful to many high performance computing needs, including seismic imaging, seismic modeling, tomography, velocity modeling, reservoir modeling, seismic inversion, etc. Applications outside the oil industry are also contemplated.

When used for fault tolerant, parallelizable assignment of tasks across multiple concurrently running task processing instances, the ATM protocol enables an arbitrary number of processing instances to be employed. Each processing instance uses the ATM API to obtain a task to do, perform that task, return that task as completed, and repeat until all tasks are complete. Should any processing instance terminate for any reason, other instances will continue processing tasks until all tasks are complete. Even if all processing instances terminate, starting new processing instances will cause the task processing to resume until all tasks are complete. New processing instances can be started at any time with the result of reducing the overall time needed to perform all tasks. Note that if the number of processing instances is ever scaled so high as to cause access to the ATM data file to become a bottleneck, the bottleneck may be alleviated by increasing the task size and/or by structuring the task list as a hierarchical tree, where a separate ATM data file represents each node of the tree and appears as a single task in the parent node. Other nesting mechanisms could also be employed.

This application of the ATM API would be suitable for Reverse Time Migration software. Another illustrative application is the distribution of database queries among a pool of database servers.

When used for allocating a pool of limited resources where demand exceeds resource availability, the ATM protocol represents the individual resources as tasks in a list. By creating a “task list” that is actually a “resource pool”, processing instances can check out a resource as though it were a task. When all resources are checked out to processing instances, subsequent checkout attempts will cause instances to wait until a resource becomes available for checkout. When a processing instance is finished with the resource it has obtained, instead of checking in the “task” as complete, it releases the resource using the ATM “taskCancel” API method. This release makes the task/resource available for checkout by another processing instance. Resource elements can represent actual real world resources like host names, physical computer cores, etc. or they could represent abstract count limits like licenses, concurrent disk access, etc.

This application of the ATM API would be suitable for obtaining exclusive write access to a network file, or read access by a limited number of instances to a network file. It would also be suitable for implementing a software license pool that limits the number of instances executing a given software package.

The ATM API can also be employed to synchronize processing instances in various fashions including one similar to the barrier function provided by the MPI (“Message Passing Interface”) standard. For example, the taskOut method described above only returns True once all the tasks in a task list have been finished, so processing instances can be readily restrained from proceeding to a subsequent processing phase until the tasks in the list are all finished. Moreover, one or more of the tasks in the list may represent the setup task(s) required for the subsequent phase, ensuring that each setup task is performed by no more than one processing instance, and that the setup task(s) are finished before any instances can proceed to the subsequent phase. If the setup tasks themselves are dependent on the completion of the preceding phase, an intermediate setup phase may be created with a task list of just the one or more setup task(s).

Arbitrarily complex procedures can be constructed with the above building blocks. Task lists can be either preset statically or created dynamically, with nesting and gating where needed. In one illustrative application for performing full waveform inversion, the initialization and collective communication can employ the ATM API for resource allocation, and a similar usage of the ATM API may be used for managing the number of processing instances based on the available computing hardware resources. Within each phase, the ATM API may be used for allocating concurrently executable tasks. For regulating progress through the phases, the ATM API may be used to enforce completion of prerequisite tasks before dependent tasks are undertaken.

Numerous other variations and modifications will become apparent to those skilled in the art once the above disclosure is fully appreciated. It is intended that the following claims be interpreted to embrace all such variations and modifications.

What is claimed is:

1. An application task management method that comprises:
populating a data structure with a list of one or more tasks, at least one of which is unfinished; and
operating a pool of multiple processing instances until the unfinished tasks are completed, each processing instance:
performing a check-out of one or more unfinished tasks with a check-out request that includes an ID of the processing instance and a task timeout value;
transforming the one or more unfinished tasks into one or more finished tasks;
providing a check-in of the one or more finished tasks; and
optionally repeating the performing, transforming, and providing,
wherein the performing and providing are each implemented using a file lock to ensure exclusive access to the data structure.

2. The method of claim 1, wherein the data structure is a file residing on a non-transient information storage medium.

3. The method of claim 2, wherein modifications to the data structure are provided by creating a replacement data structure on the non-transient information storage medium without first erasing the data structure.

4. The method of claim 1, wherein the one or more processing instances periodically issue a renewal request to extend the timeout value while transforming the one or more unfinished tasks.

5. The method of claim 1, wherein the check-out request further includes a number of unfinished tasks being requested, and wherein the number of unfinished tasks being requested is greater than one.

6. The method of claim 1, wherein the processing instances call a linked software library to implement the performing and providing.

7. The method of claim 6, wherein for the performing, the library executes a command line script to identify a requested number of unstarted or timed-out tasks in the list and to assign a new processing instance ID, start time, and time out, to the requested number of unstarted or time-out tasks in the list.

8. The method of claim 7, wherein the command line script reports that the list is complete if a stop time exists for each task in the list.

9. The method of claim 6, wherein for the providing, the library executes a command line script to assign a stop time to each of the one or more finished tasks.

10. The method of claim 1, wherein at least one task in the list comprises creating a new data structure with a list of one or more subtasks.

11. The method of claim 10, wherein the at least one task includes verifying completion of subtask prerequisites for the list of one or more subtasks.

12. A computing system that comprises:
a non-transient information storage medium having a data structure that includes a list of one or more tasks for a high-performance computing application;
one or more processing units that together execute a pool of multiple processing instances, each processing instance:
performing a check-out of one or more unfinished tasks with a check-out request that includes an ID of the processing instance and a task timeout value;
transforming the one or more unfinished tasks into one or more finished tasks;
providing a check-in of the one or more finished tasks; and
optionally repeating the performing, transforming, and providing,
wherein the performing and providing are each implemented using a file lock to ensure atomic access to the data structure.

13. The system of claim 12, wherein the high-performance computing application includes at least one of seismic imaging, interactive modeling, tomographic analysis, velocity modeling, reservoir simulation, database management.

14. The system of claim 12, wherein each processing instance periodically issues a renewal request to extend the timeout value while transforming the one or more unfinished tasks.

15. The system of claim 12, wherein the check-out request further includes a number of unfinished tasks being requested, and wherein the number of unfinished tasks being requested is greater than one.

16. The system of claim 12, wherein each processing instance calls a linked software library to implement the performing and providing.

17. The system of claim 16, wherein as part of the performing, the library executes a command line script to identify a requested number of unstarted or timed-out tasks in the list and to assign a new processing instance ID, start time, and time out, to the requested number of unstarted or time-out tasks in the list.

18. The system of claim 16, wherein as part of the providing, the library executes a command line script to assign a stop time to each of the one or more finished tasks.

19. The system of claim 12, wherein at least one task in the list comprises creating a new data structure with a list of one or more subtasks.

20. The system of claim 19, wherein the at least one task includes verifying completion of subtask prerequisites for the list of one or more subtasks.
